(19) United States
(12) Patent Application Publication
(10) Pub. No.: US 2020/0074218 A1
(43) Pub. Date: Mar. 5, 2020

(54) INFORMATION PROCESSING SYSTEM, INFORMATION PROCESSING APPARATUS, AND NON-TRANSITORY COMPUTER READABLE MEDIUM

(71) Applicant: FUJI XEROX CO., LTD., Tokyo (JP)

(72) Inventors: Sharath Vignesh GODHANTARAMAN, Kanagawa (JP); Suresh MURALI, Kanagawa (JP); Akira SEKINE, Kanagawa (JP); Shingo UCHIHASHI, Kanagawa (JP)

(73) Assignee: FUJI XEROX CO., LTD., Tokyo (JP)

(21) Appl. No.: 16/546,310

(22) Filed: Aug. 21, 2019

(30) Foreign Application Priority Data
Aug. 28, 2018 (JP) 2018-159540

(51) Int. Cl. G06K 9/62; G06K 9/00

(52) U.S. Cl. CPC G06K 9/6215; H04L 67/42; G06K 9/00369; G06K 9/00744

(57) ABSTRACT

An information processing system includes a receiving unit that receives plural target images from a user, a content identifying unit that identifies content information related to contents of the plural target images, a selection unit that selects, based on the content information, a specific image from among posted images that are posted on an Internet medium, and an extraction unit that extracts an image similar to the specific image from among the plural target images.

### CROSS-REFERENCE TO RELATED APPLICATIONS

This application is based on and claims priority under 35 USC 119 from Japanese Patent Application No. 2018-159540 filed Aug. 28, 2018.

### BACKGROUND

### (i) Technical Field

The present disclosure relates to an information processing system, an information processing apparatus, and a non-transitory computer readable medium.

### (ii) Related Art

For example, Japanese Unexamined Patent Application Publication No. 2015-43603 describes a method including steps of calculating evaluation values for a plurality of pieces of successively captured image data based on a subject included in the pieces of image data, selecting any image data from among the plurality of pieces of image data, and storing the selected image data in a memory. In the step of selecting any image data, image data having a higher evaluation value than any other pieces of image data is selected from among the plurality of pieces of image data. If the evaluation value of an image obtained through subsequent imaging is higher than the evaluation value of an image obtained through previous imaging among the plurality of pieces of image data but a difference between the evaluation values is equal to or smaller than a predetermined value, the image obtained through the previous imaging is selected.

### SUMMARY

Aspects of non-limiting embodiments of the present disclosure relate to the following circumstances. When an attempt is made to extract an image having a potential for favorable evaluations from among a plurality of target images such as images that compose a video, a user needs to check the plurality of target images or to decide what kind of image may gain favorable evaluations.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system comprising a receiving unit that receives a plurality of target images from a user, a content identifying unit that identifies content information related to contents of the plurality of target images, a selection unit that selects, based on the content information, a specific image from among posted images that are posted on an Internet medium, and an extraction unit that extracts an image similar to the specific image from among the plurality of target images.

### BRIEF DESCRIPTION OF THE DRAWINGS

An exemplary embodiment of the present disclosure will be described in detail based on the following figures, wherein:

FIG. 1 illustrates an overall image extracting system of an exemplary embodiment;

FIG. 2 illustrates the functional configuration of a server apparatus of the exemplary embodiment;

FIGS. 3A, 3B, and 3C illustrate feature points in specific images in the exemplary embodiment;

FIG. 4 is a flowchart of an operation of the image extracting system of the exemplary embodiment;

FIG. 5 illustrates a specific example of extraction of extraction images from among a plurality of frame images;

and

FIG. 6 illustrates an example of the configuration of a screen for presentation of the extraction images in the exemplary embodiment.

### DETAILED DESCRIPTION

An exemplary embodiment of the present disclosure is described blow with reference to the accompanying drawings.

### [Image Extracting System 1]

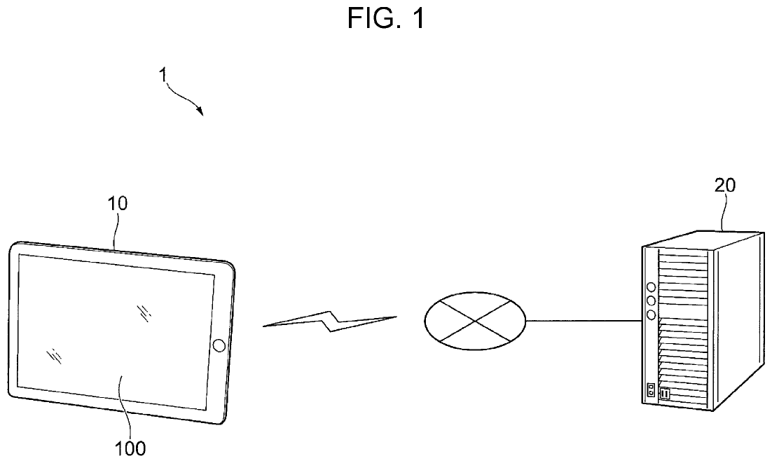

FIG. 1 illustrates an overall image extracting system 1 of this exemplary embodiment.

As illustrated in FIG. 1, the image extracting system 1 of this exemplary embodiment (example of an information processing system) includes a terminal apparatus 10 to be operated by a user, and a server apparatus 20 that extracts at least one target image from among a plurality of target images acquired from the terminal apparatus 10. In the image extracting system 1, the terminal apparatus 10 and the server apparatus 20 may mutually communicate information via a network.

The network is not particularly limited as long as the network is a communication network for use in data communication between the apparatuses. For example, the network may be a local area network (LAN), a wide area network (WAN), or the Internet. A communication line for use in data communication may be established by wire, by wireless, or by wire and wireless in combination. The apparatuses may be connected together via a plurality of networks or communication lines by using a relay apparatus such as a gateway apparatus or a router.

In the example illustrated in FIG. 1, a single server apparatus 20 is illustrated but the server apparatus 20 is not limited to the single server machine. Functions of the server apparatus 20 may be implemented by being distributed among a plurality of server machines provided on a network (so-called cloud environment or the like).

Although illustration is omitted, a plurality of server apparatuses that provide various web services such as a SNS are connected to the network illustrated in FIG. 1.

The following description is directed to an example in which the system assists extraction of an image showing a scene that may gain favorable evaluations from other persons when the user attempts to extract an image showing at least one scene from among images showing a plurality of scenes in a video captured by the user.

### [Terminal Apparatus 10]

The terminal apparatus 10 may communicate information with the outside via the network. The terminal apparatus 10 stores images captured by an imaging part mounted on its body and images captured by other photographing devices or the like.

Examples of the terminal apparatus 10 include a mobile phone such as a smartphone, a portable terminal device such as a tablet PC, and a stationary terminal device such as a desktop PC. If information is communicable with the outside via the network, examples of the terminal apparatus 10 also include a video camera that captures videos and a still camera that captures still images (hereinafter referred to as cameras).

### [Server Apparatus 20]

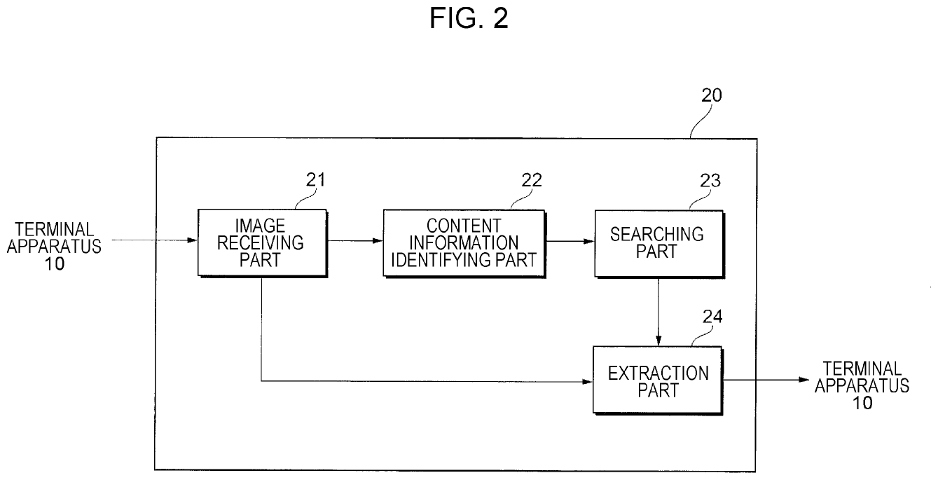

FIG. 2 illustrates the functional configuration of the server apparatus 20 of this exemplary embodiment.

As illustrated in FIG. 2, the server apparatus 20 includes an image receiving part 21 that receives a video (example of the plurality of target images) from the terminal apparatus 10, a content information identifying part 22 that identifies content information related to contents of the video, a searching part 23 that searches posted images that are posted on an Internet medium for a specific image based on the content information, and an extraction part 24 that extracts an image similar to the specific image from the video.

### (Image Receiving Part 21)

The image receiving part 21 (example of a receiving unit) receives a video from the user via the terminal apparatus 10. The video may be a video saved in the terminal apparatus 10 in advance or a video acquired from various storage media such as a removable medium connected to the terminal apparatus 10 or a camera connected to the terminal apparatus 10.

### (Content Information Identifying Part 22)

The content information identifying part 22 (example of a content identifying unit) identifies content information related to contents of the video received by the image receiving part 21. The content information identifying part 22 of this exemplary embodiment sends text-based content information to the searching part 23.

The content information identifying part 22 identifies the content information of the video by analyzing a plurality of frame images that compose the video. The content information identifying part 22 of this exemplary embodiment stores a large number of analysis images. Each analysis image is associated with text information indicating contents of the image. For example, an analysis image showing a player who plays basketball is associated with a text “basketball”. The content information identifying part 22 performs matching between the plurality of frame images that compose the video and the large number of analysis images. The content information identifying part 22 identifies an analysis image that matches a frame image that composes the video and acquires a text of the identified analysis image. The content information identifying part 22 sets the acquired text as the content information indicating the contents of the video subjected to the image analysis.

The matching between the frame image and the analysis image may be performed by using a method for use in the extraction of the specific image from among the plurality of target images by the extraction part 24 described later or by using any other existing matching technology.

If the content information of the video is identified by analyzing the images in the video, image classification to be achieved by machine learning may be used. For example, machine learning is performed by using a data group (learning data set) corresponding to a plurality of analysis images associated with texts indicating contents of the images, thereby building a post-learning model. The post-learning model classifies the video received from the user based on a classification rule obtained through the learning. In this case, the content information identifying part 22 identifies a text associated with the classification as the content information indicating the contents of the images.

The content information identifying part 22 may directly acquire the content information of the video from the user. When the image receiving part 21 receives the video, the content information identifying part 22 receives the content information of the video from the user. For example, in a case of a video showing such a scene that the sun sinks into the ocean, the user sends a text “sunset in ocean” to the image receiving part 21. The content information identifying part 22 identifies the text specified by the user as the content information indicating the contents of the video.

### (Searching Part 23)

The searching part 23 (example of a selection unit) searches the Internet medium by using, as a keyword, the content information identified by the content information identifying part 22. In this exemplary embodiment, the Internet medium is an information medium available on the Internet. Examples of the Internet medium include a social networking service (SNS), an electronic bulletin board system, and a weblog.

The searching part 23 searches the posted images that are posted on the Internet medium for a posted image corresponding to the keyword that is set by using the text-based content information (hereinafter referred to as a specific image).

The searching part 23 of this exemplary embodiment searches the Internet medium by using not only the content information identified by the content information identifying part 22 but also extended content information obtained by extending the content information. The extended content information is obtained by extending the concept of the content information. Examples of the extended content information include a paraphrase of the content information, a translation of the content information into a different language, words suggested by the content information, and a synonym for the content information. For example, if the content information is “basketball”, the searching part 23 identifies a word such as “hoops”, “baloncesto”, “shoot”, or “dunk” or a famous basketball player name as the extended content information.

When identifying the extended content information based on the content information, the searching part 23 may use a language database such as a dictionary prestored in the server apparatus 20 or may refer to a language database available on the Internet.

The searching part 23 also collects information on evaluations of the specific image obtained as a result of searching based on the keywords of the content information and the extended content information. For example, a SNS may provide a function of receiving evaluations from other users for an image posted by a certain user. When evaluations are made for the posted image that is posted on the Internet medium, the searching part 23 identifies the posted image and evaluation information related to the evaluations of the posted image.

For example, in a case of a mechanism in which a count related to evaluation is incremented by one when a viewer who views a specific image gives a positive evaluation, the evaluation may be identified based on the total count. In this case, the evaluation is more favorable as the total count increases.

The evaluation may be identified based on a count of access to, for example, a specific image or a webpage where the specific image is displayed. In this case, the evaluation is more favorable as the count of access to the specific image or the webpage where the specific image is displayed increases.

### (Extraction Part 24)

The extraction part 24 (example of an extraction unit and a presentation unit) extracts a target image similar to the identified specific image from among the plurality of target images received by the image receiving part 21. The extraction part 24 of this exemplary embodiment performs matching between the specific image and the plurality of frame images that compose the video as the plurality of target images and extracts a frame image having a highest similarity to the specific image among the plurality of frame images. In this exemplary embodiment, the extraction part 24 presents the extracted target image (hereinafter referred to as an extraction image) to the user on a screen of the terminal apparatus 10.

The extraction part 24 of this exemplary embodiment extracts a frame image similar to a specific image that is identified by the searching part 23 and gains favorable evaluations on the Internet medium. In this case, the extraction part 24 may extract a plurality of frame images from the video based on a plurality of specific images such as a specific image that gains the most favorable evaluations and a specific image that gains the second most favorable evaluations. That is, the extraction part 24 may extract frame images showing different scenes from the video based on different specific images.

The extraction part 24 may extract the extraction image by using a specific image identified based on evaluations summed up by the searching part 23 in a predetermined period instead of the entire period. For example, the searching part 23 identifies a specific image that has gained favorable evaluations relatively recently as typified by a period within several months from the search timing. The extraction part 24 extracts an extraction image similar to the specific image that has gained favorable evaluations recently.

The extraction part 24 may identify the similarity between the target image and the specific image based on a histogram related to distribution of colors that compose the images. In this case, the extraction part 24 determines that the similarity between the target image and the specific image is higher as the similarity indicated by the histogram is higher.

The extraction part 24 may identify the similarity between the target image and the specific image based on a feature portion in the images. That is, the extraction part 24 focuses on one portion in the specific image instead of the entire specific image. The extraction part 24 determines that a target image having a portion similar to the one feature portion in the specific image has a high similarity to the specific image.

The extraction part 24 may identify the similarity between the target image and the specific image based on distances between feature points in the images. The extraction part 24 detects a plurality of common feature points in the target image and in the specific image. The extraction part 24 identifies a distance between the feature points in the specific image. The extraction part 24 also identifies a distance between the feature points in the target image. The extraction part 24 determines that the similarity between the target image and the specific image is higher as the similarity of the distances between the corresponding feature points is higher.

The extraction part 24 may identify the similarity between the target image and the specific image by combining a plurality of viewpoints out of the histogram, the feature portion, and the distances between feature points.

The extraction part 24 receives, from the user, an operation of specifying the number of extraction images to be extracted from among the plurality of target images. If the user does not specify the number of extraction images, the extraction part 24 extracts a predetermined number of (for example, two) extraction images.

For example, in a video showing similar scenes, it is assumed that a plurality of similar frame images are present. In this case, the extraction part 24 selects one frame image from among the plurality of similar frame images based on a predetermined condition. Examples of the predetermined condition include a condition that the frame image is earliest on a timeline, a condition that the image is clearest, and various other conditions.

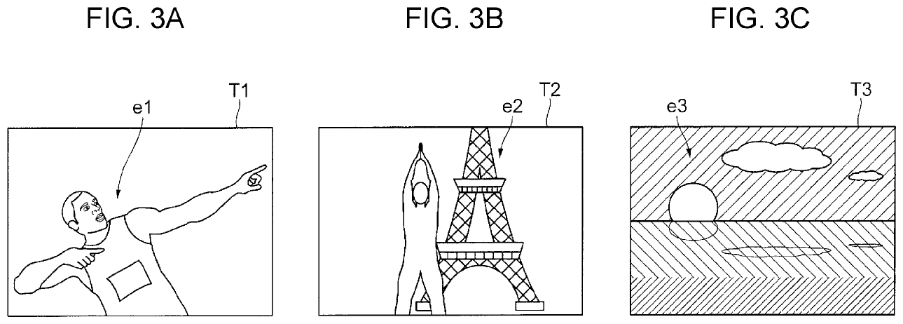

FIGS. 3A, 3B, and 3C illustrate feature points in specific images in this exemplary embodiment.

Description is made of feature points that the extraction part 24 of this exemplary embodiment focuses on when extracting a target image similar to a specific image from among a plurality of target images. In this exemplary embodiment, the extraction part 24 sets the following conditions as the feature points: (1) a pose of a person in the specific image, (2) arrangement of a person or an object in the specific image, and (3) color composition of the specific image.

### (1) Pose of Person in Specific Image

When a specific image T1 shows a person as illustrated in FIG. 3A, the extraction part 24 identifies a pose (posture) of the person. Then, the extraction part 24 extracts, as the extraction image from among the plurality of target images, a target image showing a person who assumes a pose similar or identical to the pose of the person in the specific image.

Examples of the characteristic pose of the person in the specific image T1 include a characteristic pose e1 that a famous track and field athlete assumes when he/she wins a championship. In this case, the extraction part 24 increases a rank in which a target image showing a person who assumes a pose similar or identical to the pose e1 of the famous athlete is selected as the extraction image from among the plurality of target images even if, for example, the similarities of other image elements are low.

### (2) Arrangement of Person or Object in Specific Image

As illustrated in FIG. 3B, the extraction part 24 analyzes arrangement of a person or an object in a specific image T2. Then, the extraction part 24 extracts, from among the plurality of target images, a target image having similar or identical arrangement of a person or an object.

Even if the same subject is imaged, impression obtained from the image greatly differs depending on positional relationships between a structure and a person, between structures, and between persons. Examples of the characteristic arrangement of a person or an object in the specific image T2 include arrangement e2 of a person in front of a building with his/her size smaller than that of the building. In this case, the extraction part 24 increases a rank in which a target image having similar or identical arrangement of a person or an object is selected as the extraction image from among the plurality of target images even if, for example, the similarities of other portions are low.

### (3) Color Composition of Specific Image

As illustrated in FIG. 3C, the extraction part 24 analyzes color composition of a specific image T3. Then, the extraction part 24 extracts a target image having similar or identical color composition from among the plurality of target images.

Examples of the characteristic color composition of the specific image T3 include color composition e3 of colors of the sky in the sunset. In this case, the extraction part 24 increases a rank in which a target image having similar or identical color composition is selected as the extraction image from among the plurality of target images even if, for example, the similarities of other portions are low.

The extraction part 24 may extract the extraction image from among the plurality of target images by combining a plurality of feature points out of (1) a pose of a person in the specific image, (2) arrangement of a person or an object in the specific image, and (3) color composition of the specific image.

The extraction part 24 may extract one target image from among the plurality of target images based on a plurality of specific images irrespective of evaluations of the specific images. Specifically, the searching part 23 identifies a plurality of specific images as search results based on a certain keyword. The extraction part 24 analyzes the plurality of specific images to analyze a common feature point in the plurality of specific images. Then, the extraction part 24 may extract a target image having the common feature point as the extraction image from among the plurality of target images.

Next, description is made of an operation of the image extracting system 1 of this exemplary embodiment.

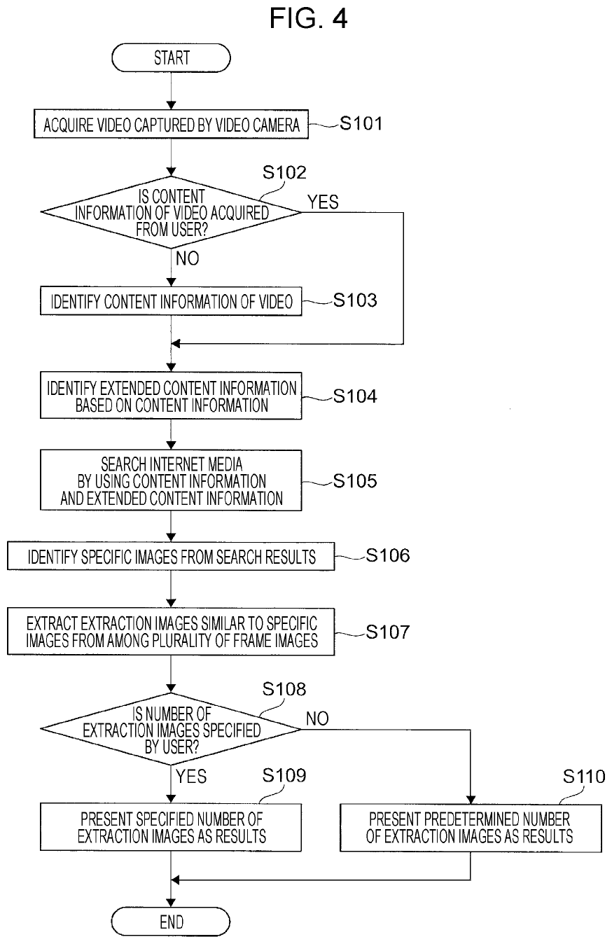

FIG. 4 is a flowchart of an operation of the image extracting system of this exemplary embodiment.

As illustrated in FIG. 4, the image receiving part 21 receives a video captured by a video camera from the user via the terminal apparatus 10 (S101).

The image receiving part 21 determines whether content information of the video is acquired from the user (S102). When the content information of the video is acquired from the user (“YES” in S102), the operation proceeds to Step 104.

When the content information of the video is not acquired from the user (“NO” in S102), the content information identifying part 22 identifies the content information of the video based on analysis of the received video (S103).

The searching part 23 identifies extended content information based on the content information identified by the content information identifying part 22 or the content information received from the user (S104).

The searching part 23 searches the Internet medium by using keywords of the content information and the extended content information (S105). As a result, the searching part 23 identifies specific images from results of searching the Internet medium (S106).

The extraction part 24 extracts target images similar to the specific images from among a plurality of frame images that compose the video (S107).

The extraction part 24 determines whether the number of extraction images is specified by the user (S108). When the number of extraction images is specified by the user (“YES” in S108), extraction images as many as the number specified by the user are presented on a screen 100 of the terminal apparatus 10 (S109). When the number of extraction images is not specified by the user (“NO” in S108), a predetermined number of extraction images are presented on the screen 100 of the terminal apparatus 10 (S110).

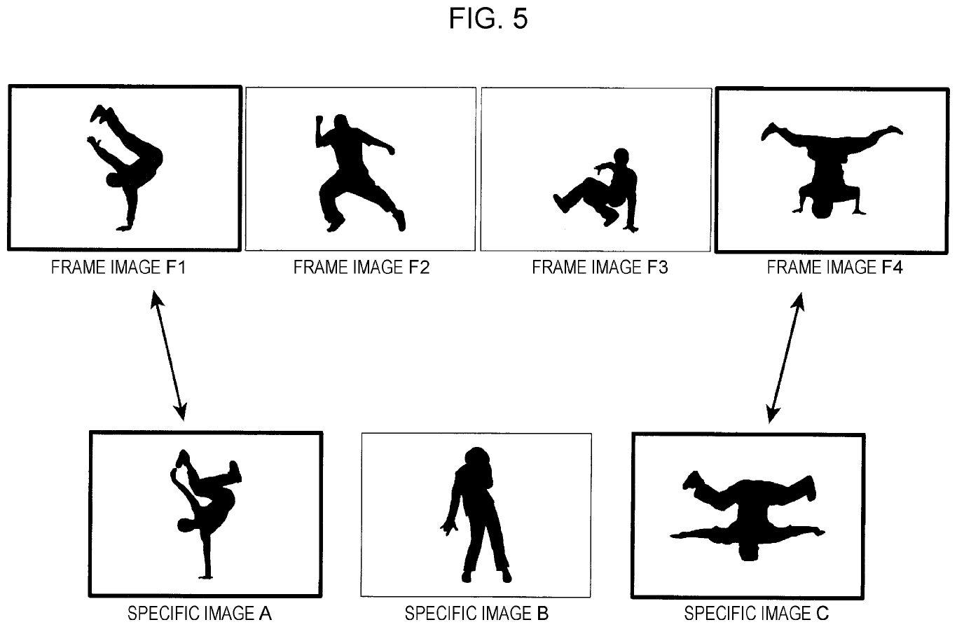

FIG. 5 illustrates a specific example of the extraction of extraction images from among a plurality of frame images.

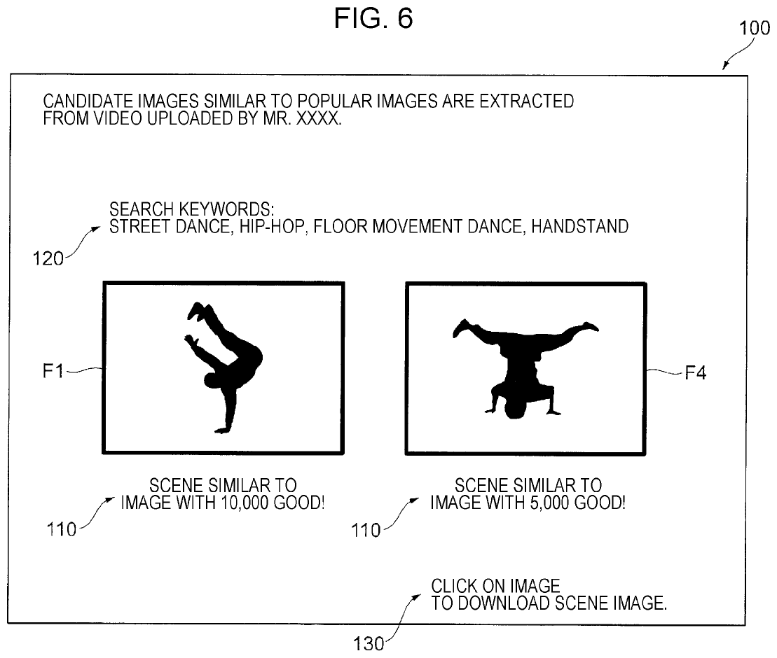

FIG. 6 illustrates an example of the configuration of the screen for presentation of the extraction images in this exemplary embodiment.

Next, description is made of the specific example of the extraction of extraction images from among a plurality of frame images.

As illustrated in FIG. 5, there are a plurality of frame images that compose a video received from the user. In the example illustrated in FIG. 5, the video shows a street dance. Four frame images (F1, F2, F3, and F4) are illustrated as representative examples of the plurality of frame images that compose the video. FIG. 5 illustrates the four frame images for convenience but there are other frame images as well.

In this example, the Internet medium is searched based on content information and extended content information of the video. First, the video of the street dance is analyzed to identify the content information as “street dance”. Further, the extended content information of “street dance” is identified as “hip-hop”, “floor movement dance”, and “handstand”.

By searching the Internet medium based on the identified content information and the identified extended content information used as keywords, a specific image A, a specific image B, and a specific image C are identified as illustrated in FIG. 5. The number of evaluations given by viewers on the Internet medium increases in the order of the specific image C, the specific image B, and the specific image A. In this example, the specific image A gains an evaluation count of “10,000 good!”. The specific image B gains an evaluation count of “7,000 good!”. The specific image C gains an evaluation count of “5,000 good!”.

A frame image similar to the specific image A, the specific image B, or the specific image C is extracted from among the plurality of frame images. In this example, the user specifies that two images are extracted.

In the example illustrated in FIG. 5, the frame image F1 is extracted as an extraction image that is a target image similar to the specific image A. In the example illustrated in FIG. 5, the frame image F4 is similarly extracted as an extraction image that is a target image similar to the specific image C.

As illustrated in FIG. 6, the extraction images are displayed on the screen 100 of the terminal apparatus 10. In this exemplary embodiment, the frame image F1 and the frame image F4 are displayed on the screen 100 of the terminal apparatus 10 as the two extraction images. Further, pieces of evaluation information 110 on the specific images that are the sources of extraction are displayed for the two extraction images, respectively. Specifically, the evaluation count on the Internet medium is displayed as the evaluation information 110.

In the example illustrated in FIG. 6, search keywords 120 for use in the search for the specific images are displayed. For example, if the keywords of the content information and the extended content information identified by analyzing the video differ from a topic expected by the user, the user may input content information again to change the keywords.

An instruction button 130 that prompts the user to select (click) the extraction image to download the extraction image in the terminal apparatus 10 as a still image is also displayed on the screen 100.

As described above, in the image extracting system 1 of this exemplary embodiment, the extraction image is extracted from the user's video based on the specific image identified on the Internet medium.

In the example described above, the plurality of frame images that compose the video are received as the plurality of target images but the target images are not limited to this example. For example, the image receiving part 21 may receive a plurality of still images captured by a camera as the plurality of target images. In this case as well, the extraction image is extracted from among the plurality of still images based on the specific image identified on the Internet medium.

Next, description is made of the hardware configurations of the terminal apparatus 10 and the server apparatus 20 of this exemplary embodiment.

Each of the terminal apparatus 10 and the server apparatus 20 of this exemplary embodiment includes a central processing unit (CPU) serving as a computing unit, a memory serving as a main memory, a magnetic disk drive (hard disk drive (HDD)), a network interface, a display mechanism including a display device, an audio mechanism, and an input device such as a keyboard and a mouse.

The magnetic disk drive stores programs of an OS and application programs. Those programs are read in the memory and executed by the CPU, thereby implementing the functions of the functional components of the server apparatus 20 of this exemplary embodiment.

A program causing the terminal apparatus 10 and the server apparatus 20 to implement the series of operations of the image extracting system 1 of this exemplary embodiment may be provided not only by, for example, a communication unit but also by being stored in various recording media.

The configuration for implementing the series of functions of the image extracting system 1 of this exemplary embodiment is not limited to the example described above. For example, all the functions to be implemented by the server apparatus 20 of the exemplary embodiment described above need not be implemented by the server apparatus 20. For example, all or a subset of the functions may be implemented by the terminal apparatus 10.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing system, comprising:
a receiving unit that receives a plurality of target images from a user;
a content identifying unit that identifies content information related to contents of the plurality of target images;
a selection unit that selects, based on the content information, a specific image from among posted images that are posted on an Internet medium; and
an extraction unit that extracts an image similar to the specific image from among the plurality of target images.

2. The information processing system according to claim 1,
wherein the plurality of target images are a plurality of frame images that compose a video, and
wherein the extraction unit extracts a frame image similar to the specific image from among the plurality of frame images.

3. The information processing system according to claim 2, wherein the content identifying unit obtains the content information through image analysis in the video.

4. The information processing system according to claim 2, wherein the content identifying unit acquires the content information of the video from the user.

5. The information processing system according to claim 1, wherein the selection unit selects, from among the posted images, a specific image corresponding to extended information obtained by extending the content information identified by the content identifying unit.

6. The information processing system according to claim 2, wherein the selection unit selects, from among the posted images, a specific image corresponding to extended information obtained by extending the content information identified by the content identifying unit.

7. The information processing system according to claim 3, wherein the selection unit selects, from among the posted images, a specific image corresponding to extended information obtained by extending the content information identified by the content identifying unit.

8. The information processing system according to claim 4, wherein the selection unit selects, from among the posted images, a specific image corresponding to extended information obtained by extending the content information identified by the content identifying unit.

9. The information processing system according to claim 1, wherein the selection unit selects the specific image from among the posted images based on evaluations of the posted images from a viewer of the posted images.

10. The information processing system according to claim 9, wherein the selection unit selects the specific image from among the posted images based on the evaluations summed up in a predetermined period.

11. The information processing system according to claim 1, wherein the extraction unit extracts, from among the plurality of target images, an image having a feature point in the specific image.

12. The information processing system according to claim 11, wherein the extraction unit uses a pose of a person in the specific image as the feature point.

13. The information processing system according to claim 11, wherein the extraction unit uses arrangement of a person or an object in the specific image as the feature point.

14. The information processing system according to claim 11, wherein the extraction unit uses color composition of the specific image as the feature point.

15. The information processing system according to claim 1, wherein the extraction unit extracts, from among the plurality of target images, an image having a common point in a plurality of the specific images.

16. An information processing apparatus, comprising:
a receiving unit that receives a plurality of target images from a user;
an extraction unit that extracts at least one image from among the plurality of target images based on evaluation information from a viewer of posted images that are posted on an Internet medium; and
a presentation unit that presents one of the target images to the user together with the evaluation information.

17. A non-transitory computer readable medium storing a program causing a computer to execute a process, the process comprising:
identifying content information related to contents of a plurality of target images received from a user;
selecting, based on the content information, a specific image from among posted images that are posted on an Internet medium; and
extracting an image similar to the specific image from among the plurality of target images.

18. A non-transitory computer readable medium storing a program causing a computer to execute a process, the process comprising:
receiving a plurality of target images from a user;
extracting at least one image from among the plurality of target images based on evaluation information from a viewer of posted images that are posted on an Internet medium; and
presenting one of the target images to the user together with the evaluation information.
